(19) United States
(12) Patent Application Publication
(10) Pub. No.: US 2024/0053309 A1
(43) Pub. Date: Feb. 15, 2024

(54) AN APPARATUS AND METHOD FOR PREDICTING RETENTION TIME IN CHROMATOGRAPHIC ANALYSIS OF ANALYTE

(71) Applicant: BERTIS INC, Seongnam-si, Gyeonggi-do (KR)

(72) Inventors: Sejun SONG, Seongnam-si (KR); Sungsoo KIM, Yongin-si (KR); Hyeonseok SHIN, Yongin-si (KR)

(73) Assignee: BERTIS INC, Seongnam-si, Gyeonggi-do (KR)

(21) Appl. No.: 18/270,528

(22) PCT Filed: Apr. 28, 2021
(86) PCT No.: PCT/KR2021/005369

§ 371 Date: Jun. 30, 2023

(30) Foreign Application Priority Data
Dec. 31, 2020 (KR) 10-2020-0189497

(51) Int. Cl. G01N 30/86; G01N 30/72; G06N 3/045

(52) U.S. Cl. CPC G01N 30/8693; G01N 30/7233; G06N 3/045; G01N 2030/027

(57) ABSTRACT

The present invention relates, with respect to liquid chromatograph-mass spectrometry (LC-MS), to a technique for predicting retention time of samples and thereby accurately separating signals of samples having mass that are close to each other to improve multiplexity of quantitative measurements.

### TECHNICAL FIELD

The present invention relates to a technique that improves the multiplexity of quantitative measurements by accurately separating signals from samples with adjacent masses through the prediction of the retention time of a sample in Liquid Chromatograph-Mass Spectrometry (LC-MS).

### BACKGROUND ART

Liquid Chromatograph-Mass Spectrometry (LC-MS) is a technology that separates target material into components by passing it through a column in a liquid state, and that separates substances with different mass-to-charge ratios via mass spectrometry after ionizing each component, and thus can be used for protein identification. When the ionization process for mass spectrometry in LC-MS is performed in tandem mode, it is referred to as LC-MS/MS.

In the LC-MS/MS technique, there is a method to perform the quantification of target substances by binding a labeling material with a known mass-to-charge ratio to the target material in advance, and specifying the spectrum of the labeling material from the spectrum obtained from mass spectrometry. Here, depending on the degree of ionization of the labeling material, the quantification technique can be subdivided into a quantification technique that uses a parent molecule-based label which is a precursor ion (MS1-based), and a quantification technique that uses a product ion-based label which is further framented from the parent molecule (MS2-based).

However, the retention time of the analyte in the liquid chromatography (LC) step greatly varies depending on various conditions, such as the type of machine, column specifications, length, laboratory temperature, humidity, etc.

In addition, when analyzing a biological sample (blood, tissue, etc.), mass spectrometry (LC-MS/MS) is performed through the mass-to-charge ratio (m/z) of a specific fragmented peptide. Here, numerous peptides with a similar mass-to-charge ratio (m/z) other than the target peptide are also detected on the chromatography, so multiple peaks are shown on the chromatogram even when a selective m/z value is entered, and hence it becomes impossible to distinguish the peak of the target peptide located at a specific retention time.

Therefore, a standard heavy peptide that is isotopically substituted at a specific molecule is used to determine the retention time of the peptide, but it is very unpractical to use isotopically substituted standard heavy peptides due to its high cost, thus the present invention enables the accurate prediction of retention time only with the physiochemical information of the analyte.

### Technical Problem

An object of the present invention relates to a method for predicting the retention time comprising the step of calculating the retention time of an analyte polymer, preferably, an analyte peptide.

Another object of the present invention relates to an apparatus for predicting the retention time of, comprising the apparatus that calculates the retention time of an an analyte polymer, preferably analyte peptide.

However, the technical problem to be achieved by the present invention is not limited to the above-mentioned problems, and other problems that are not mentioned will be clearly understood by a person having ordinary skill in the art from the following description.

### Technical Solution

Hereinafter, various embodiments described herein are described with reference to the drawings. In the following description, various specific details, such as specific forms, compositions and processes, etc., are set forth in order to provide a thorough understanding of the present invention. However, certain embodiments may be executed without one or more of these specific details, or with other known methods and forms. In other instances, well known processes and manufacturing techniques are not described in specific detail to avoid unnecessarily obscuring the present invention. References throughout this specification to “one embodiment” or “an embodiment” means that a particular feature, form, composition or characteristic described in relation to the embodiments is included in one or more embodiments of the present invention. Therefore, the appearances of “one embodiment” or “an embodiment” in various places throughout this specification do not necessarily refer to the same embodiment of the present invention. In addition, particular features, forms, compositions, or characteristics may be combined in one or more embodiments in any suitable way. Unless there is a specific definition within the present invention, all scientific and technical terms used herein have the same meaning as commonly understood by a person skilled in the art to which the present invention belongs.

According to an embodiment of the present invention, it relates to a method for predicting retention time.

As used herein, the term “retention time (RT)” refers to the time interval from when a sample is added to the chromatography until when the chromatogram peak of the component appears.

The method of the present invention may comprise the step of preparing a first target polymer (sample to be analyzed) and at least two first reference substances, each with different retention times.

In the present invention, the first target polymer is used to build a model for predicting retention time based on information regarding the target polymer whose retention time is to be predicted, and its types may be any one or more selected from organic molecules, target lipids, target carbohydrates, target DNA fragments, target RNA fragments and peptides, and preferably, the polymer may be a peptide, and the substance constituting the peptide may be an amino acid, but is not limited thereto.

In the present invention, at least one first target polymer may be comprised, but two or more may be comprised for further learning, and preferably 2 to 10 may be comprised, but is not limited thereto.

In the present invention, the first reference substance may be in the form of a polymer, but materials whose retention time can be measured in chromatography, or whose retention time is already known and can be standardized can be comprised without limitation.

In the present invention, the first reference substance may be any one or more selected from organic molecules, target lipids, target carbohydrates, target DNA fragments, target RNA fragments and peptides, and preferably, the first reference substance may be a peptide, but is not limited thereto.

In the present invention, at least two first reference substance may be comprised, and preferably 3 to 20 may be comprised, but is not limited thereto.

The method of the present invention may comprise the step of measuring the retention times of the first target polymer and the first reference substance or receiving the measured results. Hereinafter, while the actual measured retention time of the first target polymer is referred to as ‘eRT₁₋ₜ’ (experienced RT), and the actual measured retention time of the first reference substance is ‘eRT₁₋ᵣₚ’, the p may be a serial number corresponding to multiple first reference substances, and may be expressed as, for example, ‘eRT₁₋ᵣ₁’, ‘eRT₁₋ᵣ₂’, or ‘eRT₁₋ᵣ₃’, and the like.

In the present invention, the retention time of the first target polymer and the first reference substance can be measured by chromatography under the first condition. Here, the conditions may be conditions according to a chromatography apparatus or stationary phase, mobile phase, temperature, or pressure, and the like, but are not limited thereto.

In the present invention, the retention time of the first target polymer and the first reference substance can be obtained by measuring a chromatogram, but is not limited thereto.

In the present invention, the retention time of the first target polymer and the first reference substance can be measured by further adding mass spectrometry (MS) or ultraviolet spectrometry (UV) to the chromatography under the first condition, for example, by HPLC-MS or HPLC-UV, but is not limited thereto.

The method of the present invention can comprise the step of converting the actual retention time of the first target polymer (eRT₁₋ₜ), measured as described above, into an arbitrary indexed retention time. Hereinafter, the arbitrary indexed retention time of the first target polymer is referred to as ‘iRT₁₋ₜ’.

As used herein, the term “indexed retention time” is a dimensionless number that is stable for analytes of the chromatography, is generally determined through in silico prediction of previously determine analytes. Using the actual retention time(eRT₁₋ₜ) to predict the retention time has limitations such as lack of accuracy of the in silico algorithm and lack of reproducibility due to the variability of the chromatography system, but by using indexed retention time, the capability to predict retention time can be improved, since a stable numerically adjusted value can be derived each time a chromatography experiment is performed. In the present invention, the indexed retention time can be any arbitray real number, and while the value is not particularly limited, may be, for example, a real number between 0 and 100.

In the present invention, the step of classifying the first reference substance into a first set comprising one or more sets may be further comprised during the step of converting to an arbitrary indexed reference time, and preferably the predictive accuracy of retention time may increase if the first set comprises multiple sets. Hereinafter, the derived first set is referred to as ‘set-1(n)’, where the n may be a serial number for each set, and may be expressed as, for example, ‘set-1(1)’, ‘set-1(2)’, ‘set-1(3)’, and the like.

In the present invention, each set comprised in the first set can comprise at least some of the multiple reference substances, but preferably may comprise two or more reference substances, and, for example, the first set may comprise 2 to 20 reference substances for each set, but is not limited thereto.

In the present invention, the step of selecting an arbitrary indexed retention time for multiple reference substances comprised in each set may be comprised when calculating the arbitrary indexed retention time of the first target polymer (iRT₁₋ₜ). Hereinafter, while the arbitrary indexed retention time of the first reference substance is referred to as ‘iRT₁₋ᵣₚ’, the p may be a serial number corresponding to the number of first reference substances, and may be expressed as, for example, ‘iRT₁₋ᵣ₁’, ‘iRT₁₋ᵣ₂’, ‘iRT₁₋ᵣ₃’, and the like.

In the present invention, a correlational equation between the actual measured retention time (eRT₁₋ᵣₚ) and the indexed retention time (iRT₁₋ᵣₚ), the first correlational equation, can be derived from such.

In the present invention, the first correlational equation may be a linear correlational equation, and can preferably be obtained by linear regression, support vector machine (SVM), random forest, decision tree, or gradient boost machine (GBM), but is not limited thereto.

As used herein, the term “linear regression” is a statistical method that explains or predicts the relationship between an independent variable and a dependent variable when the basic assumption of linearity is satisfied.

As used herein, the term “support vector machine (SVM)” is a binary linear classification method that enable classification and regression of data, and thus can intuitively see the shape of the data.

As used herein, the term “random forest” is one of the ensemble methods, and is a data mining technique that has maximum predictive capability for input variables by putting randomness into many decision trees.

As used herein, the term “decision tree” is one kind of decision support tool that schematizes decision-making rules and its results in a tree structure.

As used herein, the term “gradient boost machine (GBM)” is a machine learning technique for regression and classification problems, and generally creates predictive functions in the form of ensembles of weak predictive functions such as decision trees.

In one example of the present invention, the first correlational equation may be expressed as Equation 1 below:

iRT=b₁*(eRT₁)+c₁ [Equation 1]

In Equation 1,
eRT₁ is the actual measured retention time of the target polymer measured in chromatography under the first condition,
iRT is the indexed retention time, and
b₁ and c₁ are each independently constants of the first correlational equation.

In the present invention, the indexed retention time (iRT₁₋ₜ) can be derived by substituting the actual measured retention time (eRT₁₋ₜ) into the first correlational equation obtained above.

In the present invention, when there are multiple first sets, the first correlational equation can be obtained for each set, and the indexed retention time (iRT₁₋ₜ) can be derived by substituting the actual measured retention time (eRT₁₋ₜ) of the first target polymer into the first correlational equation obtained for each set, in which case the indexed retention time values of the first target polymer obtained for each set may be the same or different from each other. Hereinafter, while the indexed retention time of the first target polymer obtained for each set in the first set is referred to as ‘iRT₁₋ₜ (n)’ the n may be a serial number for each first set, and may be expressed as, for example, ‘iRT₁₋ₜ(1)’, ‘iRT₁₋ₜ(2)’, ‘iRT₁₋ₜ(3)’, and the like.

In the present invention, the step of creating a predictive model that predicts the indexed retention time according to the monomer sequence of the target polymer by learning information about the first target polymer, preferably the correlation between the sequence information and the derived indexed retention time, through an artificial neural network may be comprised.

As used herein, the term “artificial neural network” consists of an input layer that receives and sends input, and several nodes, and comprises a hidden layer that receives and responds accordingly to stimuli from the input at each node, and an output layer that sums and outputs the responses of the nodes coming from the hidden layer. The artificial neural network is particularly successful because it learns from data, in other words meaning that the program acquires a largely labeled or weakly labeled training set, and after some training phase, is able to generalize to new unknown samples. The artificial neural network generally does not provide information about the reasons and methods through which a judgment is made (for example, why the monomer sequence of a particular polymer is calculated to a particular retention time), and the knowledge and relationships that determine classification judgments are rather “implicit”.

For the purposes of the present invention, the input layer is information on the first target polymer, preferably sequence information, and the output layer may be predicted values of indexed retention times. The sequence information may be the type, arrangement, polymerized number and physical properties of the monomers constituting the first target polymer, and the physical properties may be molecular weight, constituent elements and hydrophobicity, but are not limited thereto.

In the present invention, the artificial neural network may be generated by at least one of Deep Belief Network (DBN), Convolutional Neural Network (CNN), or Recurrent Neural Network (RNN), but is not limited thereto.

As used herein, the term “Deep Belief Network (DBN)” is a type of graph generation model, consists of layering multiple layers of latent variables, and learns by placing a Restricted Boltzmann Machine (RBM) in multiple layers where each node is connected in both directions.

For the purposes of the present invention, the latent variable of the Deep Belief Network may be the type, arrangement, polymerized number and physical properties of the monomers constituting the first target polymer, and the physical properties may be molecular weight, constituent elements and hydrophobicity, but are not limited thereto.

In the present invention, the “Convolutional Neural Network (CNN),” unlike other artificial neural networks that learn by connecting all areas of the input, may deriving the output layer through the convolution layer and pooling layer by extracting the parameters of the input layer.

For the purposes of the present invention, the parameters extracted from the Convolutional Neural Network may be the type, arrangement, polymerized number and physical properties of the monomers constituting the first target polymer, and the physical properties may be molecular weight, constituent elements and hydrophobicity, but are not limited thereto.

In the present invention, the “Recurrent Neural Network (RNN)” can learn the characteristics of sequential data such as time series data and text data, and hence the current output result of the cell in the neural network is affected by the previous calculation result. The Recurrent Neural Network retains memory information about previous calculation results and thus has an advantage in learning sequential data.

In the present invention, the Recurrent Neural Network stores memories in the hidden layer and sends them to the output layer. The value of the output layer (ys) and the value of the hidden layer (hs) in the s-th sequence of the input layer can be expressed as follows by using the value of the monomer corresponding to the s-th sequence (xs) and a nonlinear function. The value of the hidden layer (hs) is compressed through the activation function (a nonlinear function; a hyperbolic tangent or logistic sigmoid function) of the value of the monomer corresponding to the s-th sequence (xs) and the coefficient matrix (Wsh), and the value of the hidden layer at the s−1-th sequence (h(s−1)) and the coefficient matrix (Whh). The value of the hidden layer (hs) of the current state, the s-th sequence, is updated by receiving the value of the previous hidden layer (h(s−1)), and the value of the output layer of the current state (ys) is updated by receiving the value of the hidden layer (hs) of the current state. In this way, the deep neural network algorithm calculates the output value of the current state by considering the result of processing the input value of the current state and the input value of previous states together. At every point, the Recurrent Neural Network algorithm may learn the stationary characteristics of continuous signals in the process of sharing parameters. Since data is stored in the hidden layer (h) when processing the data, the Recurrent Neural Network may have the ability to remember.

In the present invention, the Recurrent Neural Network may comprise at least one selected from long short-term memory models (LSTM) and Gated Recurrent Units (GRU). The long short-term memory models and Gated Recurrent Units may solve the gradient vanishing problem of general Recurrent Neural Networks. The gradient vanishing problem is a phenomenon that the model does not learn when the point of input of information and the point of use of information are far apart that the gradient of the loss of the hidden layer does not back-propagate, consequently the gradient of calculated loss approaches to 0.

In the present invention, the “long short-term memory models (LSTMs)” decides what information the model will store and remember at each point in time by configuring each LSTM block to operate like a memory, may be composed of several layers, and the way the configuration, placement, and loss thereof of LSTM blocks is reflected in the LSTM blocks may be changed in order to properly learn the predictive model.

In the present invention, the “Gated Recurrent Units (GRU)” uses the same gating mechanism as the long short-term memory model, but may be a unit that consists of a reset gate and an update gate by reducing parameters to learn through the interaction between the reset gate and the update gate, and the way the configuration, placement, and loss thereof of each GRU is reflected in the GRU in the Gated Recurrent Units may be changed in order to properly learn the predictive model.

For the purposes of the present invention, the characteristic information of the input value learned from the Recurrent Neural Network may be connected to a full connected network (FCN) to come out as the predicted value of the desired indexed retention time (iRT predict). This connected network can learn based on the relationship between the monomer sequence of the first target polymer obtained above and the indexed retention time. Here, learning can occur by obtaining loss from the relationship between the above data pair, in other words, the sequence of the inputted first target polymer and predicted value of the indexed retention time (iRT predict), and any indexed retention time converted above, and the weight of the network can be updated trough the obtained loss.

In the present invention, the loss may use Mean Square Error (MSE). The weight of the network may be updated according to the loss that minimizes the Mean Square Error, but any loss calculation method used to infer continuous values such as the indexed retention time can be used without limitation.

In the present invention, the predictive model may be obtained by learning the correlation between information of the first target polymer and the indexed retention time derived for each first set, and the plural predictive models obtained through learning are preferable because its plurality can increase the predictive accuracy of retention time. Hereinafter, while each derived predictive model is referred to as ‘model (n)’, the n is a serial number for each first set, model(n) may be a model learned by iRT₁₋ₜ (n), and may be expressed as, for example, ‘model(1)’ learned by iRT₁₋ₜ(1), ‘model(2)’ learned by iRT₁₋ₜ(2), ‘model(3)’ learned by iRT₁₋ₜ(3), and the like.

In the present invention, learning may consist of using a plurality of different artificial neural networks. By using a plurality of different artificial neural networks for learning, a predictive model with a changed learning method that looks at various aspects of data may be obtained, thus preventing overfitting during learning, and as a result, the predictive accuracy of retention time may improve.

In the present invention, learning methods can be changed by changing the configuration of nodes, such as the type or number of nodes, of the artificial neural network. By changing the configuration of nodes, it is possible to prevent overfitting when the predictive model is learning, and as a result, the predictive accuracy may increase.

The method of the present invention can comprise the step of predicting the indexed retention time of the second target polymer (iRT₂₋ₜ) based on the information, preferably the sequence, of the second target polymer using the predictive model obtained by learning above.

In the present invention, the second target polymer is the target polymer for which the retention time is to be predicted, may be, for example, at least one selected from small organic molecules, target lipids, target carbohydrates, target DNA fragments, target RNA fragments and peptides, may preferably be a peptide, and the substance constituting the peptide may be an amino acid, but is not limited thereto.

In the present invention, the second target polymer may be plural. When the second target polymer is plural, the retention time of the multiple second target polymers may be predicted at once through a single chromatographic analysis.

In the present invention, the second target polymer may have physical properties similar to those of the first target polymer, but is not limited thereto. Here, the physical properties may be the number of monomers constituting the second target polymer or the hydrophobicity of the polymer, but is not limited thereto. When the second target polymer has similar physical properties to the first target polymer, the predictive accuracy of the retention time of the second target polymer may increase.

In the present invention, when there are multiple predictive models, the indexed retention time of the second target polymer (iRT₂₋ₜ) may be obtained for each model. Hereinafter, while the derived indexed retention time of the second target polymer (iRT₂₋ₜ) is referred to as ‘iRT₂₋ₜ(n)’, the n is a serial number for each first set, iRT₂₋ₜ(n) may be a retention time obtained by model(n), and may be expressed as, for example, ‘iRT₂₋ₜ(1)’ obtained by model(1), iRT₂₋ₜ(2)′ obtained by model(2), ‘iRT₂₋ₜ(3)’ obtained by model(3), and the like.

The method of the present invention may further comprise the step of measuring the retention time of the second reference substance or receiving the measured results. Hereinafter, while the measured retention time of the second reference substance is referred to as ‘eRT_{z-rq}’, the q may be the serial number according to multiple second reference substances, and may be expressed as, for example, ‘eRT₂₋ᵣ₁’, ‘eRT₂₋ᵣ₂’, ‘eRT₂₋ᵣ₃’, and the like.

In the present invention, the second reference substance may be in the form of a polymer, but materials whose retention time can be measured in chromatography, or whose retention time is already known and can be standardized can be comprised without limitation.

In the present invention, the second reference substance may be any one or more selected from organic molecules, target lipids, target carbohydrates, target DNA fragments, target RNA fragments and peptides, and preferably, the second reference substance may be a peptide, but is not limited thereto.

In the present invention, the second reference substance may be the same as or different from the first reference substance.

For the purpose of the present invention, at least two second reference substance may be comprised, and preferably 3 to 20 may be comprised, but is not limited thereto.

In the present invention, the retention time of the second reference substance can be measured by chromatography under the second condition. Here, the conditions may be conditions according to a chromatography apparatus or stationary phase, mobile phase, temperature, or pressure, and the like, but are not limited thereto, and the second condition may be the same as or different from the first condition.

In the present invention, the retention time of the second reference substance can be obtained by measuring a chromatogram, but is not limited thereto.

In the present invention, the retention time of the second reference substance can be calculated by further adding mass spectrometry (MS) or ultraviolet spectrometry (UV) to the chromatography under the second condition, for example, by HPLC-MS or HPLC-UV, but is not limited thereto.

The method of the present invention can further comprise the step of predicting the actual retention time of the second target polymer from the predicted indexed retention time of the second target polymer (iRT₂₋ₜ). Hereinafter, the actual retention time of the second target polymer is referred to as ‘eRT₂₋ₜ’, but the actual retention time of the second target polymer derived in each set is referred to as ‘eRT₂₋ₜ(n)’. Here, the n is the serial number per each first set, ‘eRT₂₋ₜ(n)’ may be the retention time obtained by ‘iRT₂₋ₜ(n)’, and may be expressed as, for example, ‘eRT₂₋ₜ(1)’ obtained by ‘iRT₂₋ₜ(1)’, ‘eRT₂₋ₜ(2)’ obtained by ‘iRT₂₋ₜ(2)’, ‘eRT₂₋ₜ(3)’ obtained by ‘iRT₂₋ₜ(3)’, and the like.

In the present invention, the step of classifying the second reference substance into a second set comprising one or more sets may be further comprised during the step of predicting the actual retention time, and preferably the predictive accuracy of retention time may increase if the second set comprises multiple sets. Hereinafter, the derived second set is referred to as ‘set-2(m)’, where the m may be a serial number for each second set, and may be expressed as, for example, ‘set-2(1)’, ‘set-2(2)’, ‘set-2(3)’, and the like.

In the present invention, each set comprised in the second set can comprise at least some of the multiple reference substances, but preferably may comprise two or more reference substances, and, for example, the second set may comprise 2 to 20 reference substances for each set, but is not limited thereto.

In the present invention, a second correlational equation can be derived for each set in the second set.

In the present invention, the step of selecting an arbitrary indexed retention time for multiple reference substances comprised in each set may be comprised when predicting the actual retention time of the second target polymer (eRT₂₋ₜ). Hereinafter, while the arbitrary indexed retention time of the second reference substance is referred to as ‘iRT_{2-rq}’, the q may be a serial number corresponding to the number of second reference substances, and may be expressed as, for example, ‘iRT₂₋ᵣ₁’, ‘iRT₂₋ᵣ₂’, ‘iRT₂₋ᵣ₃’, and the like.

In the present invention, a correlational equation between the measured retention time (eRT_{2-rq}) and the indexed retention time (iRT_{2-rq}), the second correlational equation, can be derived from such.

In the present invention, the second correlational equation may be a linear correlational equation, and can preferably be obtained by linear regression, support vector machine (SVM), random forest, decision tree, or gradient boost machine (GBM), but is not limited thereto.

In the present invention, the second correlational equation may be expressed as Equation 2 below:

eRT₂=b₂*(iRT)+c₂ [Equation 2]
In Equation 2,
eRT₂ is the retention time measured in chromatography under the second condition,
iRT is the indexed retention time, and
b₂ and c₂ are each independently constants of the second correlational equation.

In the present invention, the predicted value of the actual retention time of the second target polymer (eRT₂₋ₜ) in the chromatography of the second condition can be derived by substituting the indexed retention time of the second target polymer (iRT₂₋ₜ) into the second correlational equation obtained above, in which case the predicted value of the actual retention time values of the second target polymer obtained for each set may be the same or different from each other. Hereinafter, while the actual retention time of the second target polymer obtained for each set in the second set is referred to as eRT₂₋ₜ(m)′ the m may be a serial number for each second set, and may be expressed as, for example, eRT₂₋ₜ(1)′, eRT₂₋ₜ(2)′, eRT₂₋ₜ(3)′, and the like.

The method of the present invention can further comprise the step of obtaining one final actual retention time from the derived predicted value of the actual retention time of the multiple second target polymers for each set (eRT₂₋ₜ). Hereinafter, the predicted value of the final actual retention time of the second target polymer is referred to as ‘eRT_{final-t}’.

In the present invention, the final actual retention time (eRT_{final-t}) may be obtained as a specific value or a range.

In the present invention, the final actual retention time (eRT_{final-t}) may be the median value, average value, or weighted average value of the multiple eRT₂₋ₜ(m), but is not limited thereto.

In the present invention, the weighted average value may be calculated by Equation 3 below, but is not limited thereto:

eRT_{final-t}=a₁*eRT₂₋ₜ(1)+a₂*eRT₂₋ₜ(2)+ . . . +aₙ*eRT₂₋ₜ(m) [Equation 3]
In Equation 3,
a₁ to aₙ are weights, each independently a real number between 0 and 1, but a₁+a₂+aₙ=1.

In one example of the present invention, the weight can be obtained by using at least one of the metric determined during the step of creating a predictive model or the loss value of verified data, but is not limited thereto. In another example of the present invention, the weight can be determined according to the similarity of physical properties between the second target polymer and the second reference substance, but is not limited thereto. Here, the physical properties may be the number of monomers constituting the polymer or the hydrophobicity of the polymer, but is not limited thereto.

In another example of the present invention, the smaller the absolute value of the difference between the retention time of the second reference substance comprised in each set of the second set, the average value of retention times of multiple second reference substances (iRT_{2-rq}), or the median value of retention times of multiple second reference substances (iRT_{2-rq}), and the indexed retention time of the second target polymer derived from that set (iRT₂₋ₜ (m)), in other words, the value calculated by Equation 4 below, the higher the weight value.

|u(m)−iRT₂₋ₜ(m)| [Equation 4]
In Equation 4,
u(m) may be the average value or median value of any indexed retention time of multiple second reference substances comprised in the second set of serial number m.

In the present invention, the weight can be assigned to all second sets, but can be assigned to a part of sets that were randomly selected from second sets, preferably 1 to 10 sets or 1 to 5 sets from the set with the smallest absolute value.

The method of the present invention can further comprise the step of displaying the predicted value of the final actual retention time of the second target polymer (eRT_{final-t}) as obtained above on the chromatogram of the chromatography under the second condition.

According to an another embodiment of the present invention, it relates to a apparatus for predicting retention time.

In the present invention, the apparatus can comprise a sample preparation module which comprise at least two reference materials, each having a different retention time, and a first target polymer.

In the present invention, the first target polymer is used to build a model for predicting retention time based on information regarding the target polymer whose retention time is to be predicted, and its types may be any one or more selected from organic molecules, target lipids, target carbohydrates, target DNA fragments, target RNA fragments and peptides, and preferably, the polymer may be a peptide, and the substance constituting the peptide may be an amino acid, but is not limited thereto.

In the present invention, at least one first target polymer may be comprised, but two or more may be comprised for further learning, and preferably 2 to 10 may be comprised, but is not limited thereto.

In the present invention, the first reference substance may be in the form of a polymer, but materials whose retention time can be measured in chromatography, or whose retention time is already known and can be standardized can be comprised without limitation.

In the present invention, the first reference substance may be any one or more selected from organic molecules, target lipids, target carbohydrates, target DNA fragments, target RNA fragments and peptides, and preferably, the first reference substance may be a peptide, but is not limited thereto.

In the present invention, at least two first reference substance may be comprised, and preferably 3 to 20 may be comprised, but is not limited thereto.

The apparatus of the present invention can comprise the first receiving module for measuring the retention time of the first target polymer and the first reference substance or receiving the measured results. Hereinafter, while the measured retention time of the first target polymer is referred to as ‘eRT₁₋ₜ’, and the measured retention time of the first reference substance is ‘eRT_{1-rq}’, the p may be a serial number corresponding to multiple first reference substances, and may be expressed as, for example, ‘eRT₁₋ᵣ₁’, ‘eRT₁₋ᵣ₂’, or ‘eRT₁₋ᵣ₃’, and the like.

In the present invention, the retention time of the first target polymer and the first reference substance can be measured by chromatography under the first condition. Here, the conditions may be conditions according to a chromatography apparatus or stationary phase, mobile phase, temperature, or pressure, and the like, but are not limited thereto.

In the present invention, the retention time of the first target polymer and the first reference substance can be obtained by measuring a chromatogram, but is not limited thereto.

In the present invention, the retention time of the first target polymer and the first reference substance can be measured by further adding mass spectrometry (MS) or ultraviolet spectrometry (UV) to the chromatography under the first condition, for example, by HPLC-MS or HPLC-UV, but is not limited thereto.

The apparatus of the present invention can comprise the first calculating module which converts the actual retention time of the first target polymer (eRT₁₋ₜ), measured as described above, into an arbitrary indexed retention time. Hereinafter, the arbitrary indexed retention time of the first target polymer is referred to as ‘iRT₁₋ₜ’.

In the present invention, the first calculating module can further comprise first set generator which classifies the first reference substance into a first set and preferably the predictive accuracy of retention time may increase if the first set comprises multiple sets. Hereinafter, the derived first set is referred to as ‘set-1(n)’, where then may be a serial number for each set, and may be expressed as, for example, ‘set-1(1)’, set-1(2)′, ‘set-1(3)’, and the like.

In the present invention, the first set can comprise at least some of the multiple reference substances, but preferably may comprise two or more reference substances, and, for example, the first set may comprise 2 to 20 reference substances for each first set, but is not limited thereto.

In the present invention, the first calculating module can comprise the first converting module which selects an arbitrary indexed retention time for multiple reference substances comprised in each first set. Hereinafter, while the arbitrary indexed retention time of the first reference substance is referred to as the p may be a serial number corresponding to the number of first reference substances, and may be expressed as, for example, ‘iRT₁₋ᵣ₁’, ‘iRT₁₋ᵣ₃’, and the like. And the indexed retention time values of the first reference substance can be set in the range of 0 to 100, and depending on each first reference substance, it is possible to assign iRT₁₋ᵣ₁=10, iRT₁₋ᵣ₂=50, and iRT₁₋ᵣ₃=90.

In the present invention, the first converting module can derive the first correlational equation between the measured actual retention time(eRT₁) of chromatography under the first condition and the indexed retention time(iRT), from the measured actual retention time (eRT₁₋ᵣₚ) of the selected plural first reference substances and the indexed retention time (iRT₁₋ᵣₚ).

In the present invention, the first correlational equation may be a linear correlational equation, and can preferably be obtained by linear regression, support vector machine (SVM), random forest, decision tree, or gradient boost machine (GBM), but is not limited thereto.

In the present invention, the first correlational equation may be expressed as Equation 1 below:

iRT=b₁*(eRT₁)+c₁ [Equation 1]
In Equation 1,
eRT₁ is the retention time measured in chromatography under the first condition,
iRT is the indexed retention time, and
the b₂ and c₂ are each independently constants of the first correlational equation.

In the present invention, the indexed retention time (iRT₁₋ₜ) can be derived by substituting the actual measured retention time (eRT₁₋ₜ) into the first correlational equation obtained above.

In the present invention, when there are multiple first sets, the first correlational equation can be obtained for each set, and the indexed retention time (iRT₁₋ₜ) can be derived by substituting the actual measured retention time (eRT₁₋ₜ) of the first target polymer into the first correlational equation obtained for each set, in which case the indexed retention time values of the first target polymer obtained for each set may be the same or different from each other. Hereinafter, while the indexed retention time of the first target polymer obtained for each set in the first set may be expressed as ‘iRT₁₋ₜ (n)’ and the like.

In the present invention, the apparatus can comprise the second calculating module which creates a predictive model that predicts the indexed retention time by learning information about the first target polymer, preferably the correlation between the sequence information and the derived indexed retention time, through an artificial neural network.

For the purposes of the present invention, the input layer is information on the first target polymer, preferably sequence information, and the output layer may be predicted values of indexed retention times. The sequence information may be the type, arrangement, polymerized number and physical properties of the monomers constituting the first target polymer, and the physical properties may be molecular weight, constituent elements and hydrophobicity, but are not limited thereto.

In the present invention, the artificial neural network may be generated by at least one of Deep Belief Network (DBN), Convolutional Neural Network (CNN) or Recurrent Neural Network (RNN), but is not limited thereto.

For the purposes of the present invention, the latent variable of the Deep Belief Network may be the type, arrangement, polymerized number and physical properties of the monomers constituting the first target polymer, and the physical properties may be molecular weight, constituent elements and hydrophobicity, but are not limited thereto.

For the purposes of the present invention, the parameters extracted from the Convolutional Neural Network may be the type, arrangement, polymerized number and physical properties of the monomers constituting the first target polymer, and the physical properties may be molecular weight, constituent elements and hydrophobicity, but are not limited thereto.

In the present invention, the Recurrent Neural Network may comprise at least one selected from long short-term memory models (LSTM) and Gated Recurrent Units (GRU).

For the purposes of the present invention, the characteristic information of the input value learned from the Recurrent Neural Network may be connected to a full connected network (FCN) to come out as the predicted value of the desired indexed retention time (iRT predict). This connected network can learn based on the relationship between the monomer sequence of the first target polymer obtained above and the indexed retention time. Here, learning can occur by obtaining loss from the relationship between the above data pair, in other words, the sequence of the inputted first target polymer and predicted value of the indexed retention time (iRT predict) and any indexed retention time converted above, and the weight of the network can be updated trough the obtained loss.

In the present invention, the loss may use Mean Square Error (MSE). The weight of the network may be updated according to the loss that minimizes the Mean Square Error, but any loss calculation method used to infer continuous values such as the indexed retention time can be used without limitation.

In the present invention, the predictive model may be obtained by learning the correlation between information of the first target polymer and the indexed retention time derived for each first set, and the plural predictive models obtained through learning are preferable because its plurality can increase the predictive accuracy of retention time. Hereinafter, while each derived predictive model is referred to as ‘model (m)’, the m is a serial number for each first set, model(m) may be a model learned by iRT₁₋ₜ(m), and may be expressed as, for example, ‘model(1)’ learned by iRT₁₋ₜ(1), ‘model(2)’ learned by iRT₁₋ₜ(2), ‘model(3)’ learned by iRT₁₋ₜ(3), and the like.

In the present invention, learning may consist of using a plurality of different artificial neural networks. By using a plurality of different artificial neural networks for learning, a predictive model with a changed learning method that looks at various aspects of data may be obtained, thus preventing overfitting during learning, and as a result, the predictive accuracy of retention time may improve.

In the present invention, learning methods can be changed by changing the configuration of nodes, such as the type or number of nodes, of the artificial neural network. By changing the configuration of nodes, it is possible to prevent overfitting when the predictive model is learning, and as a result, the predictive accuracy may increase.

In the present invention, the apparatus can comprise the third calculating module which predicts the indexed retention time of the second target polymer (iRT₂₋ₜ) based on the information, preferably the sequence, of the second target polymer using the predictive model obtained by learning above.

In the present invention, the second target polymer is the target polymer for which the retention time is to be predicted, may be, for example, at least one selected from small organic molecules, target lipids, target carbohydrates, target DNA fragments, target RNA fragments and peptides, may preferably be a peptide, and the substance constituting the peptide may be an amino acid, but is not limited thereto.

In the present invention, the second target polymer may be plural. When the second target polymer is plural, the retention time of the multiple second target polymers may be predicted at once through a single chromatographic analysis.

In the present invention, the second target polymer may have physical properties similar to those of the first target polymer, but is not limited thereto. Here, the physical properties may be the number of monomers constituting the second target polymer or the hydrophobicity of the polymer, but is not limited thereto. When the second target polymer has similar physical properties to the first target polymer, the predictive accuracy of the retention time of the second target polymer may increase.

In the present invention, when there are multiple predictive models, the indexed retention time of the second target polymer (iRT₂₋ₜ) may be obtained for each model. Hereinafter, while the derived indexed retention time of the second target polymer (iRT₂₋ₜ) is referred to as ‘iRT₂₋ₜ(n)’, the n is a serial number for each first set, iRT₂₋ₜ(n) may be a retention time obtained by model(n), and may be expressed as, for example, ‘iRT₂₋ₜ(1)’ obtained by model(1), iRT₂₋ₜ(2)′ obtained by model(2), ‘iRT₂₋ₜ(3)’ obtained by model(3), and the like.

In the present invention, the apparatus can further comprise the second receiving module for measuring the retention time of the second target polymer or receiving the measured results. Hereinafter, while the measured retention time of the second reference substance is referred to as ‘eRT_{2-rq}’, the q may be the serial number according to multiple second reference substances, and may be expressed as, for example, ‘eRT₂₋ᵣ₁’, ‘eRT₂₋ᵣ₂’, ‘eRT₂₋ᵣ₃’, and the like.

In the present invention, the second reference substance may be in the form of a polymer, but materials whose retention time can be measured in chromatography, or whose retention time is already known and can be standardized can be comprised without limitation.

In the present invention, the second reference substance may be any one or more selected from organic molecules, target lipids, target carbohydrates, target DNA fragments, target RNA fragments and peptides, and preferably, the second reference substance may be a peptide, but is not limited thereto.

In the present invention, the second reference substance may be the same as or different from the first reference substance.

For the purpose of the present invention, at least two second reference substance may be comprised, and preferably 3 to 20 may be comprised, but is not limited thereto.

In the present invention, the retention time of the second reference substance can be measured by chromatography under the second condition. Here, the conditions may be conditions according to a chromatography apparatus or stationary phase, mobile phase, temperature, or pressure, and the like, but are not limited thereto, and the second condition may be the same as or different from the first condition.

In the present invention, the retention time of the second reference substance can be obtained by measuring a chromatogram, but is not limited thereto.

In the present invention, the retention time of the second reference substance can be calculated by further adding mass spectrometry (MS) or ultraviolet spectrometry (UV) to the chromatography under the second condition, for example, by HPLC-MS or HPLC-UV, but is not limited thereto.

In the present invention, the apparatus can further comprise fourth calculating module which predicts the actual retention time of the second target polymer from the predicted indexed retention time of the second target polymer (iRT₂₋ₜ). Hereinafter, the actual retention time of the second target polymer is referred to as ‘eRT₂₋₄’, but the actual retention time of the second target polymer derived in each set is referred to as ‘eRT₂₋ₜ(n)’.

In the fourth calculating module of the present invention, to predict the actual rentention time of the second target polymer, the second reference substance can be plural. And the correlational equation between the measured retention time of chromatography under the second condition (eRT) and indexed retention time (iRT) can be derived from the measured retention time of plurality of second reference substances (eRT_{2-rq}) and indexed retention time(iRT_{2-rq}). Hereinafter, the arbitrary indexed retention time of second reference substance may be referred to as ‘iRT_{2-rq}’.

In the fourth calculating module of the present invention can further comprise the classification of the second reference substance into one or more of the second sets, and the plurality of the second sets is preferable because its plurality can increase the predictive accuracy of retention time. Hereinafter, while each derived second set is referred to as ‘set-2’, the sets derived from the each second set is referred to as ‘set-2(m)’. Here, the m is a serial number for each second set, and may be expressed as, for example, ‘set-2(2)’, set-2(2)′, ‘set-2(3)’, and the like.

In the present invention, the second set can comprise at least some of the multiple reference substances, but preferably may comprise two or more reference substances, and, for example, the second set may comprise 2 to 20 reference substances for each set, but is not limited thereto.

In the present invention, a second correlational equation can be derived for each set in the second set.

In the present invention, the second correlational expression equation may be a linear correlational equation, and can preferably be obtained by linear regression, support vector machine (SVM), random forest, decision tree, or gradient boost machine (GBM), but is not limited thereto.

In the present invention, the second correlational equation may be expressed as Equation 2 below:

eRT₂=b₂*(iRT)+c₂ [Equation 2]
In Equation 2,
eRT₂ is the retention time measured in chromatography under the second condition,
iRT is the indexed retention time, and
b₂ and c₂ are each independently constants of the second correlational expression.

In the present invention, the predicted value of the actual retention time of the second target polymer (eRT₂₋ₜ) in the chromatography of the second condition can be derived by substituting the indexed retention time of the second target polymer (iRT₂₋ₜ) into the second correlational equation obtained above.

In the present invention, the apparatus can further comprise fifth calculating module which obtains the one final actual retention time from the derived predicted value of the actual retention time of the multiple second target polymers (eRT₂₋ₜ). Hereinafter, the final predicted value of the actual retention time of the second target polymer is referred to as ‘eRT_{final-t}’.

In the present invention, the final actual retention time (eRT_{final-t}) may be obtained as a specific value or a range. In the present invention, the final actual retention time (eRT_{final-t}) may be the median value, average value, or weighted average value of the multiple eRT₂₋ₜ(n), but is not limited thereto.

In the present invention, the weighted average value may be calculated by Equation 3 below, but is not limited thereto:

eRT_{final-t}=a₁*eRT₂₋ₜ(1)+a₂*eRT₂₋ₜ(2)+ . . . +aₙ*eRT₂₋ₜ(n) [Equation 3]
In Equation 3,
a₁ to aₙ are weights, each independently a real number between 0 and 1, but a₁+a₂+aₙ=1.

In one example of the present invention, the weight can be obtained by using at least one of the metric determined in the second calculating module or the loss value of verified data, but is not limited thereto.

In another example of the present invention, the weight can be determined according to the similarity of physical properties between the second target polymer and the second reference substance, but is not limited thereto. Here, the physical properties may be the number of monomers constituting the polymer or the hydrophobicity of the polymer, but is not limited thereto.

In another example of the present invention, the smaller the absolute value of the difference between the retention time of the second reference substance comprised in each set of the second set, the average value of retention times of multiple second reference substances (iRT_{2-rq}), or the median value of retention times of multiple second reference substances (iRT_{2-rq}), and the indexed retention time of the second target polymer derived from that set (iRT₂₋ₜ (m)), in other words, the value calculated by Equation 4 below, the higher the weight value.

|u(m)−iRT₂₋ₜ(m)| [Equation 4]
In Equation 4,
u(m) may be the average value or median value of any indexed retention time of multiple second reference substances comprised in the second set of serial number m.

In the present invention, the weight can be assigned to all second sets, but can be assigned to a part of sets that were randomly selected from second sets, preferably 1 to 10 sets or 1 to 5 sets from the set with the smallest absolute value.

In the present invention, the apparatus can further comprise output section which displays the predicted value of the final actual retention time of the second target polymer(eRT_{final-t}) as obtained above on the chromatogram of the chromatography under the second condition.

### Advantageous Effects of Invention

In the case of the present invention, the retention time of the analyte polymer can be predicted with high accuracy, and accordingly, the quantitative accuracy of the analyte polymer can be increased, or the section of retention time at which the analyte polymer or other substances to be analyzed exist or section of retention time at which they do not exist in the chromatogram can be determined.

### BRIEF DESCRIPTION OF DRAWINGS

FIG. 1 illustrates the measuring of the chromatographic retention time for a sample comprising the reference substance and the target polymer in an embodiment of the present invention.

FIG. 2 illustrates the process of obtaining the prediction values of multiple arbitrary indexed retention times in Example 3 of the present invention.

FIG. 3 illustrates the process of obtaining the arbitrary retention times of the first target polymer in Example 2 of the present invention.

FIG. 4 illustrates the process of generating 10 predictive models that predict indexed retention times in Example 4 of the present invention.

FIG. 5 illustrates the process of obtaining the indexed retention time by measuring the chromatographic retention time for a sample comprising the second target polymer in Example 5 of the present invention.

FIG. 6 illustrates the process of reconverting the indexed retention time of the second target polymer into the predicted value of the actual retention time in Example 5 of the present invention.

FIG. 7 illustrates the process of reconverting the indexed retention time of the second target polymer into the predicted value of the actual retention time in Example 5 of the present invention.

FIG. 8 illustrates the process of calculating the actual retention time of the second target polymer in Example 6 of the present invention.

FIG. 9 illustrates the retention time of the second target polymer in Example 7 of the present invention.

FIG. 10 illustrates the retention time of the second target polymer in Example 7 of the present invention.

FIG. 11 illustrates the retention time of the second target polymer in Example 7 of the present invention.

FIG. 12 illustrates the retention time of the second target polymer in Example 7 of the present invention.

FIG. 13 illustrates the ability to predict the retention time of the second target polymer as confirmed on a scatter plot in Example 9 of the present invention.

FIG. 14 illustrates ability to predict the retention time of the second target polymer as confirmed on a scatter plot in Example 9 of the present invention.

FIG. 15 ability to predict the retention time of the second target polymer as confirmed on a scatter plot in Example 10 of the present invention.

### BEST DESCRIPTION FOR IMPLEMENTING THE INVENTION

According to one embodiment of the present invention, it relates to a method of predicting retention time comprising the step of preparing the first target polymer and at least two first reference substances each with different retention times;
the step of measuring the retention times of the first target polymer and the first reference substance or receiving the measured results;
the step of converting the retention time of the first target polymer (eRT₁₋ₜ) to an arbitrary indexed retention time (iRT₁₋ₜ);
the step of generating a predictive model that predicts the indexed retention time according to information regarding the first target polymer by learning the correlation between the information regarding the first target polymer and the derived indexed retention time through an artificial neural network, and
the step of predicting the indexed retention time of the second target polymer (iRT₂₋ₜ) based on information regarding the second target polymer using the predictive model.

### DETAILED DESCRIPTION OF INVENTION

Hereinafter, the present invention will be explained in more detail by way of examples. However, these examples are only for exemplifying the present invention, and the contents of the present invention are not limited by these examples.

### EXAMPLES

### Example 1. Measurement of the Actual Retention Time of the First Target Polymer and Reference Substance

FIG. 1 is a flowchart for measuring the retention rate of the first target polymer and reference substance, and more specifically, the peptide represented by SEQ ID NO: 1 was first prepared as the first target polymer, and five reference substances (ST1, ST2, ST3, ST4 and ST5) with different retention times were prepared. Then, the actual retention time of the first target polymer and the five reference substances (ST1, ST2, ST3, ST4 and ST5) in the chromatography under the first condition (eRT(target), eRT(st1), eRT(st2), eRT(st3), eRT(st4), eRT(st5)) were measured.

### Example 2. Conversion to Indexed Retention Time of the First Target Polymer

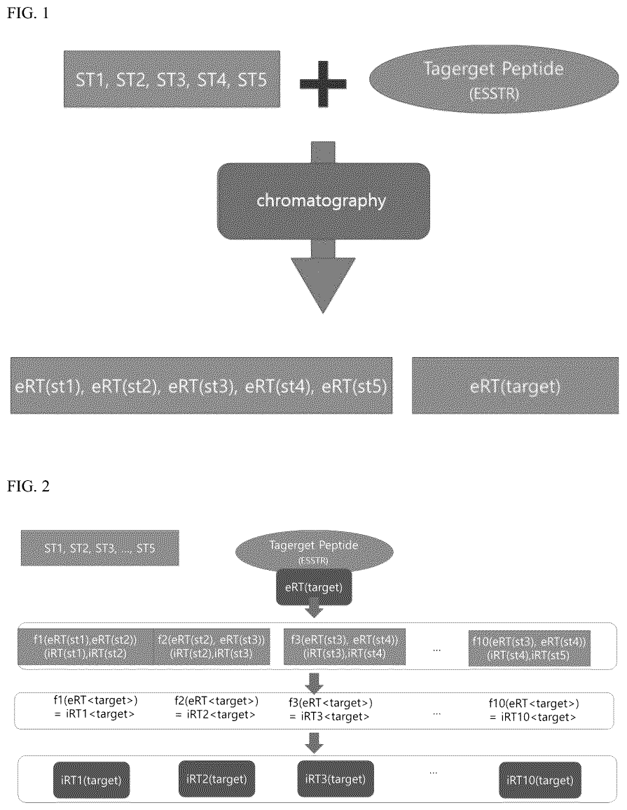

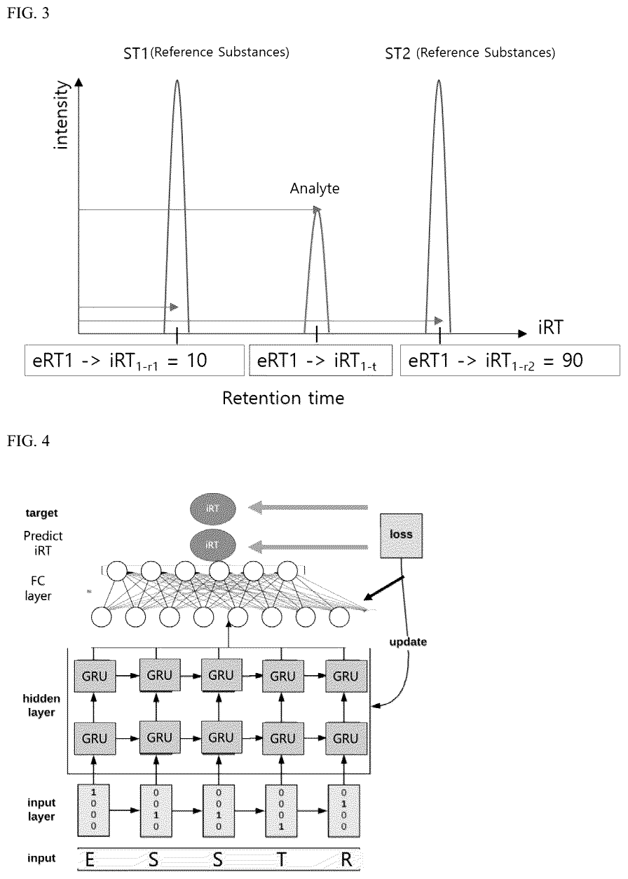

Next, in order to convert the measured retention time of the first target polymer to the indexed retention time, the conversion was proceeded according to the flowcharts shown in FIGS. 2 and 3. First, as shown in FIG. 3, an arbitrary indexed retention time was selected for each of the five reference substances (ST1, ST2, ST3, ST4 and ST5). For example, the indexed retention time of reference substance ST1 can be selected as 10, and the indexed retention time of reference substance ST2 can be selected as 90. Then, after obtaining a total of 10 sets consisting of the five substances (ST1, ST2, ST3, ST4 and ST5), 2 randomly in each set, the first correlational equation corresponding to Equation 5 below was derived for each set using the measured retention times and indexed retention times of the 2 reference substances in each set (f1 to f10).

iRTn=fn(eRT₁)=b₁₋ₙ*(eRT₁)+c₁₋ₙ [Equation 5]
In Equation 5,
eRT₁ is the measured retention time of the target polymer measured in the chromatography under the first condition,
iRTn is the indexed retention time derived by fn,
n is the serial number for each set, and
b₁₋ₙ and c₁₋ₙ are each independently constants of the first correlational equation in the set of serial number n.

As one example, the first correlational equation derived from set-1(1) comprising ST1 and ST2 as reference substances can be expressed as Equation 6 below, and Equation 6 can be completed by substituting the indexed retention time of ST1, 10, and the measured retention time of ST1 into the ‘iRT’ and ‘eRT₁’ value of Equation 6, respectively, and then deriving b₁₋ₙ and c₁₋ₙ by substituting the indexed retention time of of ST2, 90, and the measured retention time of ST2.

iRT1=f1(eRT₁)=b₁₋₁*(eRT₁)+c₁₋₁ [Equation 6]

Although not shown in the drawings, when each set comprises 3 or more reference substances, the first correlational expression can be obtained by a linear regression method using both the measured retention times and indexed retention times of the three reference substances.

Then the indexed retention time (multiple iRT1(target) to iRT10(target)) of the first target polymer was derived by substituting eRT(target), the measured retention time of the first target polymer, into the first correlational expression obtained for each set.

### Example 3. Generation of Predictive Models Using Artificial Intelligence

Then, a predictive model was generated according to the flowchart shown in FIG. 4 to enable the prediction of indexed retention time based on the sequence information of the target polymer. The model is learned by updating the weights of the network thorough the loss obtained by the relationship between the indexed retention time value to be predicted according to the amino acid sequence of the first target polymer inputted (iRT predict) and iRT1(target) to iRT10(target). Here, the loss of Mean Square Error (MSE), which is used to infer continuous values such as indexed retention time values, was used. However, when obtaining the 10 predictive models (Model1 to Model10), it can learn by changing the structure of each model. When the structure of each model is different, the model can learn by looking at various aspects of the data, thus prevent overfitting during learning, and as a result, the predictive accuracy may improve. As such, a trained model can be obtained by changing the configuration of nodes in the learning model.

### Example 4. Prediction of Indexed Retention Time Value of the Second Target Polymer

Next, as shown in FIG. 5, the indexed retention time value of the second target polymer was predicted through the sequence of the second target polymer. Specifically, “iRT1(target) predict” to “iRT10(target) predict”, which are 10 indexed retention times, were derived by entering the sequence of the second target polymer, represented by SEQ ID NO: 2, into Model1 to Model1®, the previously created predictive models.

### Example 5. Prediction of Actual Retention Time Value of the Second Target Polymer

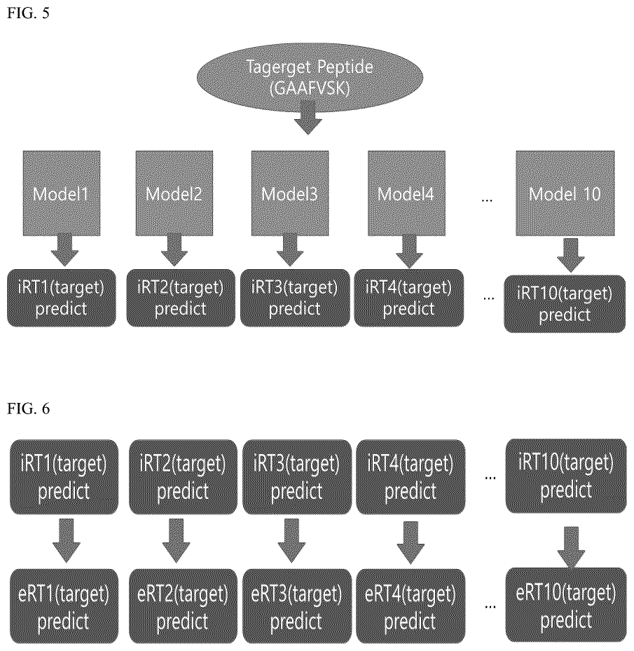

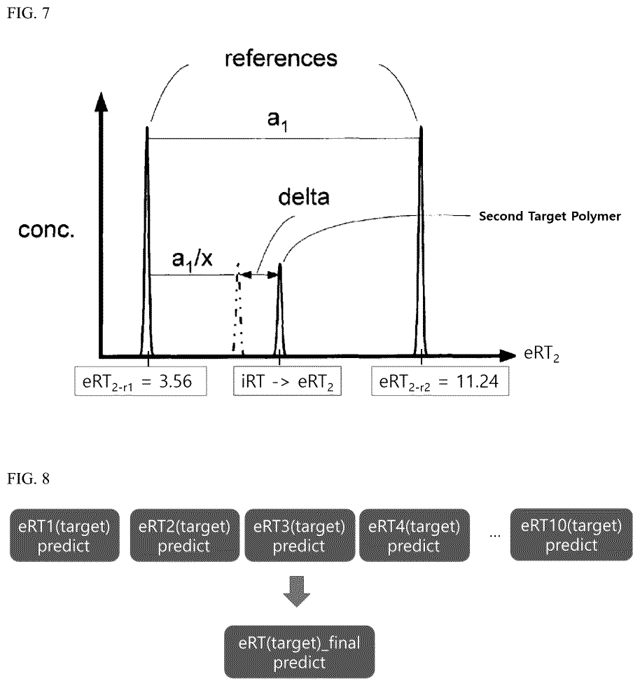

Next, as shown in FIGS. 6 and 7, “eRT1(target) predict” to “eRT10(target) predict”, which are actual retention time values in chromatography, were predicted by the previously derived “iRT1(target) predict” to “iRT10(target) predict”. The derivation process was performed by generating the second correlational equation of Equation 2 below.

eRT₂=b₂*(iRT)+c₂ [Equation 2]
In Equation 2,
eRT₂ is the retention time measured in chromatography to be predicted,
iRT is the indexed retention time, and b₂ and c₂ are constants of the second correlational equation.

As one example, in the chromatography under the conditions to be predicted, the measured retention time of reference substance ST1 (eRT₂₋ᵣ₁) and the measured retention time of reference substance ST2 (eRT₂₋ᵣ₂) were measured as 3.56 and 11.24, and when the indexed retention time of reference substance ST1 and the indexed retention time of reference substance ST2 were set to 10 and 90 as in Example 2 above, Equation 2 can be completed by deriving b₂ and c₂ by substituting the measured retention time and indexed retention time of reference substance ST1 into the values of ‘eRT2’ and ‘iRT’ of Equation 2, and then substituting the measured retention time and indexed retention time of reference substance ST2.

Then, “eRT1(target) predict” to “eRT10(target) predict”, which are predicted values of actual retention times of the second target polymer, can be obtained by entering “iRT1(target) predict” to “iRT10(target) predict”, which are indexed retention times of the second target polymer, into Equation 2.

Although not shown in the drawings, the second correlational expression can be generated by combining the data of three or more reference substances, and can be generated by learning the data of the reference substances by at least one of linear regression, support vector machine (SVM), random forest, decision tree, or gradient boost machine (GBM).

### Example 6. Derivation of the Final Actual Retention Time Value of the Second Target Polymer (1)

Next, as shown in FIG. 8, “eRT(target)_final predict”, the only final actual retention time value, was derived from “eRT1(target) predict” to “eRT10(target) predict” values, which are the 10 predicted values of the actual retention times of the second target polymers obtained in Example 5 above.

As one example, the final predicted value may be determined by the average value, or median value of the “eRT1(target) predict” to “eRT10(target) predict” values, or by the average or median values of remaining loss values stored during learning of each model from which the maximum and minimum values are excluded. And the final actual retention time value may be determined by the average or median values of remaining predicted values of each model from which the maximum and minimum values are excluded.

As another example, as shown in Equation 7 below, the “eRT(target)_final predict”, which predicts the retention time of the second target polymer, can be calculated by the weighted average of “eRT1(target) predict” to “eRT10(target) predict values”, which are the 10 retention time values of the second target polymers obtained in Example 5 above.

eRT(target)_final predict=a₁*eRT1(target)predict+a₂*eRT2(target)predict+a₃*eRT3(target)predict . . . +a₁₀*eRT10(target)predict [Equation 7]

In Equation 7,

a₁+a₂+a₃ . . . a₁₀=1.

More specifically, the final actual retention time can be obtained by applying weight to the predicted value of the actual retention time of the second target polymer obtained from each predictive model as shown in Equation 7. Here, the weight can be determined using a combination of at least one of the determined metric learned by the models or the loss value of validation data, and may, for example, apply weight differently depending on the difference between the hydrophobicity values corresponding to the sequence of the second target polymer and the hydrophobicity values of the reference substances. For example, higher weight can be applied to eRT which is predicted in a model with small hydrophobicity difference between the first target polymer and the reference substances chosen when learning each predictive model, and lower weight can be applied to eRT predicted in a model with a relatively large difference in hydrophobicity values. Or, the weight to be applied to the Pred_iRT values of the second target polymer predicted in each model can be determined based on differences between the Base_iRT value and the predicted values of the retention time of the second target polymer (Pred_iRT) after generating the base indexed retention time (Base_iRT), which is the median value of the indexed retention times of the reference substances chosen for each set when learning each predictive model. As a specific example, if the first predictive model specified the indexed retention times of the two referenced substances comprised in set-1(1) as 40 and 50, respectively, and learned with these iRT values, the Base_iRT of the first predictive model can be set as (40+50)/2=45. Similarly, if the second predictive model specified the indexed retention times of the two referenced substances comprised in set-1(2) as 50 and 70, respectively, and learned with these iRT values, the Base_iRT of this model can be set at (50+70)/2=60. In this way, the Base-iRT of the 10 predictive models were set as 45, 50, 52, 54, 55, 60, 61, 64, 66, and 71. Thereafter, using these predictive models, the Pred_iRT based on the sequence of the second target polymer was predicted to be 62, and the absolute values of the difference between Base_iRT and Pred_iRT for each predictive model were calculated to be 17, 12, 10, 8, 7, 2, 1, 3, 4, and 9. If the smallest absolute value of the difference between Base_iRT and Pred_iRT for each predictive model is set to 0 and the largest to 9, an arrangement like 9, 8, 7, 5, 4, 1, 0, 2, 3, 6 can be obtained. Only the top three arrangements with the smallest absolute value of differences were designated among these acquired arrangements, and the weights were assigned to themas 0.5, 0.3 and 0.2 respectively, and the weight for the remaining arrangements were assigned to 0. Thus, the weighted average value was obtained by assigning weight to only some of a₁ to a₁₀ in Equation 7. In addition, when selecting one representative value after obtaining weight as shown above, it can be obtained by using at least one combination of the mean or median, or the median excluding the largest and smallest values.

### Example 7. Representation of the Predicted Value of the Final Actual Retention Time of the Second Target Polymer

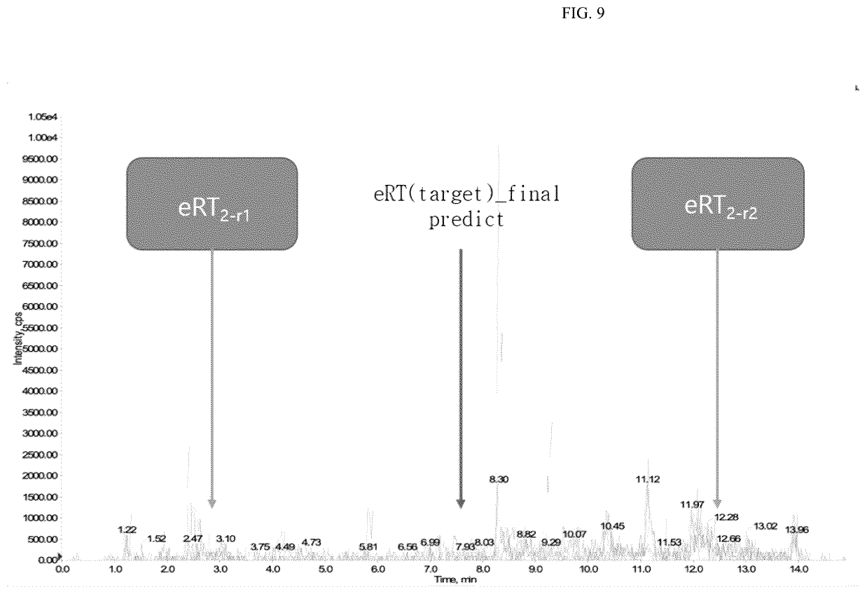

The actual retention time of the second target polymer previously calculated is plotted on the chromatogram. As one example, as shown in FIG. 9, eRT₂₋ᵣ₁ and eRT₂₋ᵣ₂, the retention times of reference substance ST1 and reference substance ST2 measured in chromatography under the conditions to be predicted, and the predicted value of the final actual retention time of the second target polymer predicted according to the second correlational equation can be displayed on the spectrum result display unit.

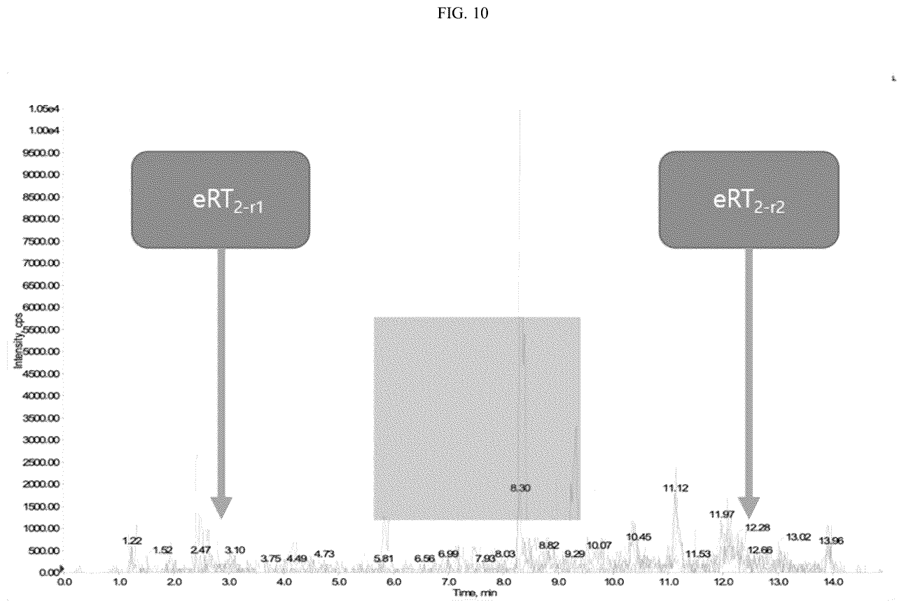

In addition, as shown in FIG. 10, it can be expressed as a spectrum interval by setting eRT1(target) to eRT10(target), which are predicted values of the actual retention time of the second target polymer obtained from the 10 predictive models, as the range. Here, the range can be represented as a range of a minimum to maximum value among the predicted values eRT1(target) to eRT10(target), or can be represented by making the center of the maximum and minimum values of the predicted values correspond to the median value of the predicted value, based on the median value of eRT1(target) to eRT10(target).

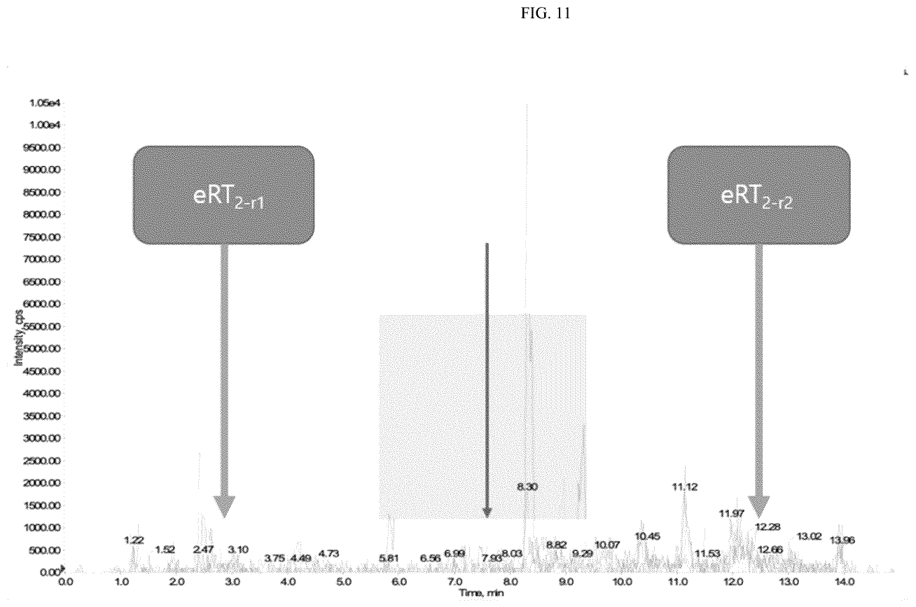

In addition, as shown in FIG. 11, the predicted values of the actual retention time of the second target polymer obtained from the 10 predictive models can be represented simultaneously as a range and a specific value.

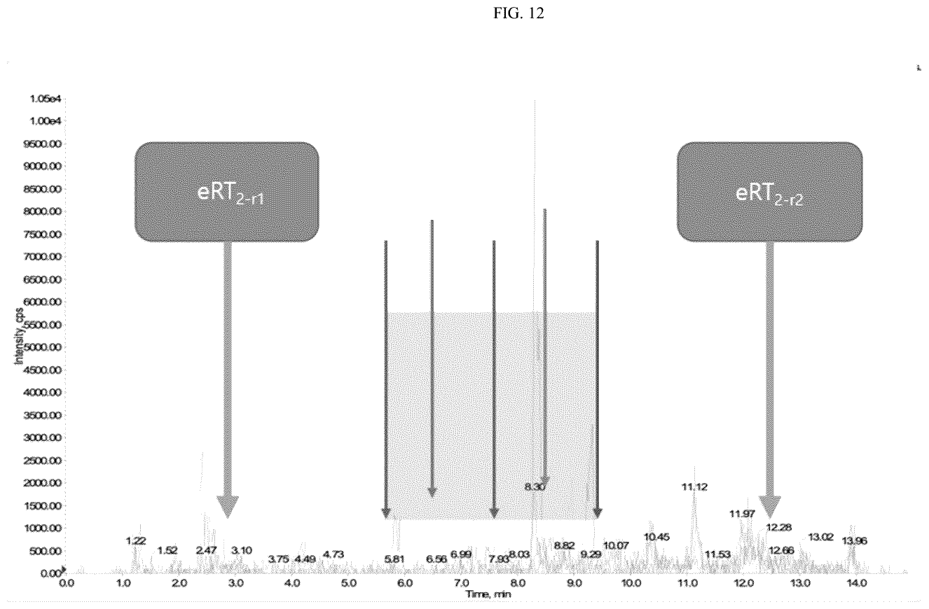

In addition, as shown in FIG. 12, each predicted value can be represented using a combination of at least one of different colors, line segment thickness, or line segment shape (dotted line, straight line, etc.) even while simultaneously representing the predicted values of the actual retention time of the second target polymer obtained from the 10 predictive models as a range and a specific value.

### Example 8. Assessment of Ability to Predict Retention Time (1)

In order to evaluate the ability to predict retention time of the present invention, the actual retention time measurement value of each second target polymer was compared to the retention time value predicted by the model (eRT). Specifically, a separate chromatography experiment using a target polymer other than the second target polymer used throughout Experiment 1 to 6 was conducted, and the results of deriving the Pearson correlation coefficient and the average value of the difference between the predicted values of retention time and actual measured retention time value are shown in Table 1 below.

TABLE 1

| | | Average value |
|---|---|---|
| | | of the |
| | Pearson correlation | difference between |
| | coefficient between | the predicted and |
| | predicted and | correct value |
| Classification | correct values | (ERT) (unit:minutes) |
| Predicted value through a | 0.9544082535758929 | 0.6686682239087796 |
| single model | | |
| Predicted value obtained | 0.9820257126151561 | 0.3772901068190545 |
| by executing mean | | |
| ensemble after creating | | |
| multiple models | | |
| Predicted value obtained | 0.9810834480736677 | 0.33677121991309833 |
| by executing weight | | |
| min distance mean | | |
| ensemble after creating | | |
| multiple models | | |

As shown in Table 1, the Pearson correlation coefficient is closer to 1 with smaller error when predicting the retention time by generating multiple models rather than one predictive model, showing that cases in which multiple predictive models were used had higher predictive abilities.

### Example 9. Assessment of Ability to Predict Retention Time (2)

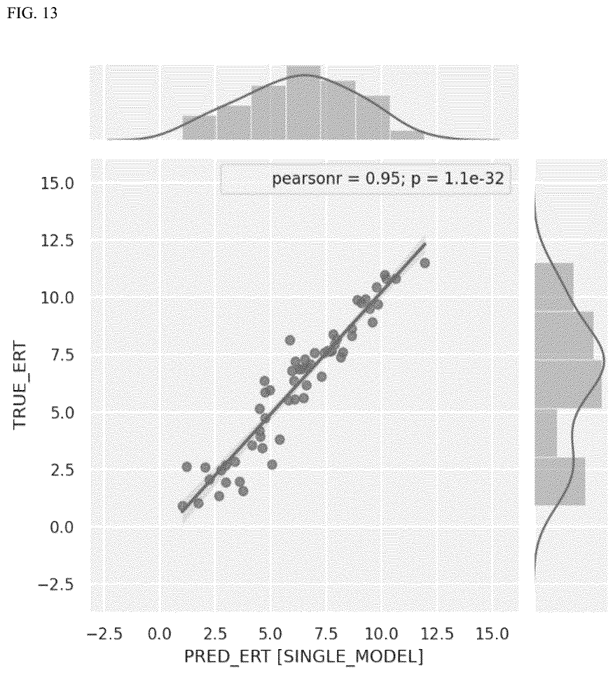

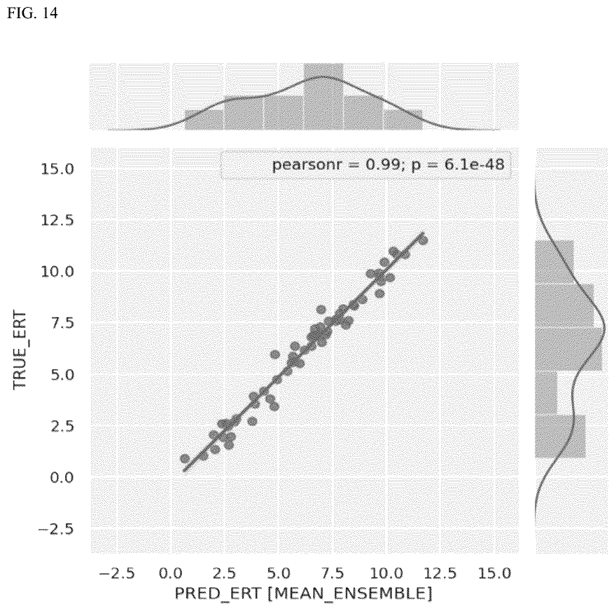

In order to evaluate the ability to predict retention time of the present invention, the actual retention time measurement value of each second target polymer was compared to the retention time value predicted by the model (eRT). Specifically, a separate chromatography experiment using a target polymer other than the second target polymer used throughout Experiment 1 to 6 was conducted, and a scatterplot of the predicted values of retention time derived from one predictive model and the actual measured retention time value are shown in FIG. 13, and a scatterplot of the predicted values of retention time derived from multiple predictive models and the actual measured retention time value are shown in FIG. 14.

As shown in FIGS. 13 and 14, the Pearson correlation coefficient is closer to 1 with smaller error when predicting the retention time by generating multiple models rather than one predictive model, showing that cases in which multiple predictive models were used had higher predictive abilities.

### Example 10. Assessment of Ability to Predict Retention Time (3)

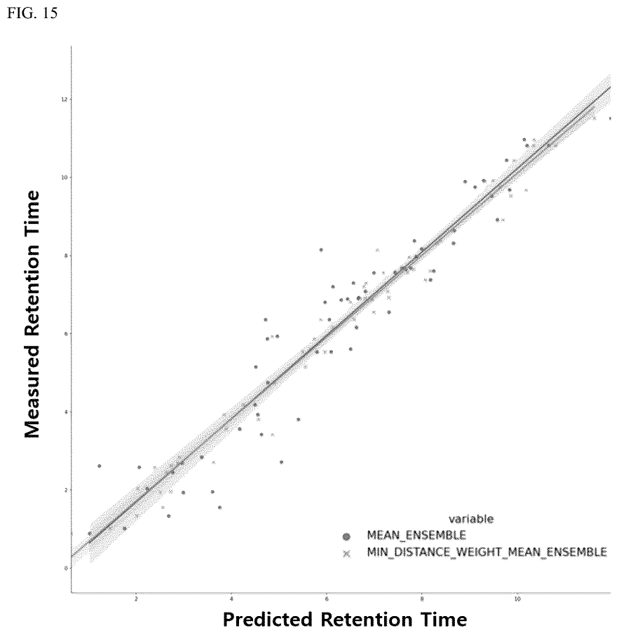

In order to evaluate the ability to predict retention time of the present invention, the actual retention time measurement value of each second target polymer was compared to the retention time value predicted by the model (eRT). Specifically, a separate experiment using a target polymer other than the polymer used throughout Experiments 1 to 6 was conducted, and a scatterplot of the predicted values obtained by performing mean ensemble after generating multiple models and predicted values obtained by performing weight min distance mean ensemble after generating multiple models are shown in FIG. 15.

As shown in FIG. 15, the data given weight based on the distance of the Base_iRT (weight median) expresses the highest correlation between the left Y value (True_ERT) and the lower X value (Pred_ERT) because the data are concentrated on the prediction line.

As such, when using the method of predicting the retention time of the present invention, the retention time of the second target polymer to be predicted was predicted with high accuracy.

### INDUSTRIAL APPLICABILITY

The present invention relates to a technique that improves the multiplicity of quantitative measurements by accurately separating signals from samples with adjacent masses through the prediction of the retention time of a sample in Liquid Chromatograph-Mass Spectrometry (LC-MS).

1. A method of predicting retention time comprising:
the step of preparing the first target polymer and at least two first reference substances each with different retention times;
the step of measuring the retention times of the first target polymer and the first reference substance or receiving the measured results;
the step of converting the retention time of the first target polymer (eRT₁₋ₜ) to an arbitrary indexed retention time (iRT₁₋ₜ);
the step of generating a predictive model that predicts the indexed retention time according to information regarding the first target polymer by learning the correlation between the information regarding the first target polymer and the derived indexed retention time through an artificial neural network; and
the step of predicting the indexed retention time of the second target polymer (iRT₂₋ₜ) based on information regarding the second target polymer using the predictive model.

2. The method according to claim 1,
wherein the first target polymer is at least one selected from the group consisting of organic molecules, target lipids, target carbohydrates, target DNA fragments, target RNA fragments and peptides

3. The method according to claim 1,
wherein the first target polymers are 2 or more.

4. The method according to claim 1,
wherein the step of converting to an arbitrary indexed retention time comprises the step of classifying the first reference substance into a first set comprising multiple sets, and each set comprises at least some of the first reference substances.

5. The method according to claim 4,
wherein the step of converting the retention time of the first target polymer (eRT₁₋ₜ) to an arbitrary indexed retention time (iRT₁₋ₜ) further comprises the step of deriving a first correlational equation, which is a correlation between the measured retention time and indexed retention time of at least two first reference substances; and the step of deriving the indexed retention time (iRT₁₋ₜ) by substituting the measured retention time of the first target polymer into the first correlational equation.

6. The method according to claim 5,
wherein the first correlational equation is obtained by at least one of selected from the group consisting of linear regression, support vector machine (SVM), random forest, decision tree, and gradient boost machine (GBM).

7. The method according to claim 1,
wherein the artificial neural network is at least one selected from the group consisting of Deep Belief Network (DBN), Convolutional Neural Network (CNN), and Recurrent Neural Network (RNN).

8. The method according to claim 1,
wherein the learning is conducted by multiple different artificial neural networks.

9. The method according to claim 1,
wherein the second target polymer is at least one selected from the group consisting of organic molecules, target lipids, target carbohydrates, target DNA fragments, target RNA fragments and peptides.

10. The method according to claim 5,
wherein the method further comprises the step of measuring the retention times of at least two second target polymers or receiving the measured results.

11. The method according to claim 10,
wherein the method further comprises the step of predicting the actual retention time (eRT₂₋₄) of the second target polymer from the predicted indexed retention rate (iRT₂₋ₜ) of the second target polymer.

12. The method according to claim 11,
wherein the step of predicting the actual retention time (eRT₂₋ₜ) further comprises the step of deriving a second correlational equation, which is a correlation between the measured retention time and indexed retention time of the second reference substance, and the step of predicting the actual retention time (eRT₂₋ₜ) by substituting the indexed retention time of the second target polymer into the second correlational equation.

13. The method according to claim 12,
wherein prior to the step of deriving the second correlational equation, the method comprises the step of classifying the second reference substance into a second set comprising multiple sets, and wherein the each set comprises at least some of the second reference substances.

14. The method according to claim 11,
wherein the predictive models are multiple, and
wherein the method further comprises the step of obtaining one final actual retention time (eRT_{final-t}) from the predicted value of the actual retention time (eRT₂₋ₜ) of the second target polymer derived from each predictive model.

15. The method according to claim 14,
wherein the final actual retention time (eRT_{final-t}) is a median value or average of the multiple predicted values of actual retention time; or weighted average obtained by applying weights to the multiple predicted values of actual retention times.

16. The method according to claim 15,
wherein the weight is obtained by using at least one of the metric or the loss value of validation data determined during the step of generating predictive models.

17. The method according to claim 15,
wherein the weight is determined according to the similarity of physical property between the second target polymer and the second reference substance, and
wherein the physical property is the number of monomers constituting the polymer or the hydrophobicity of the polymer.

18. The method according to claim 15,
wherein the weight is assigned higher values as the absolute value of the difference between the average or median value of the retention times of the multiple first reference substances used in generating each predictive model and the indexed retention time of the second target polymer derived from the predictive model becomes smaller.

19. An apparatus that predicts retention time comprising:
a first receiving module for measuring the retention times of the first target polymer and at least two first reference substances or receiving the measured results;
a first calculation module for converting the retention time of the first target polymer (eRT₁₋ₜ) to an arbitrary indexed retention time (iRT₁₋ₜ);
a second calculation module for generating a predictive model that predicts the indexed retention time according to sequence information by learning the correlation between the information regarding the first target polymer and the derived indexed retention time through an artificial neural network; and
a third calculation module for predicting the indexed retention time of the second tar get polymer (iRT₂₋ₜ) based on information regarding the second target polymer by using the predictive model.

20. (canceled)

21. (canceled)

22. (canceled)

23. (canceled)

24. (canceled)

25. (canceled)

26. (canceled)

27. (canceled)


SEQUENCE LISTING (2 sequences)

SEQ ID NO: 1 - protein, 5 aa, Artificial Sequence
  peptide fragment
ESSTR

SEQ ID NO: 2 - protein, 7 aa, Artificial Sequence
  peptide fragment
GAAFVSK